(19) United States
(12) Patent Application Publication
(10) Pub. No.: US 2024/0019596 A1
(43) Pub. Date: Jan. 18, 2024

(54) AUDIO-BASED OCCUPANCY DETECTION

(71) Applicant: Carrier Corporation, Palm Beach Gardens, FL (US)

(72) Inventor: David Mannfeld, Carmel, IN (US)

(21) Appl. No.: 18/350,279

(22) Filed: Jul. 11, 2023

Related U.S. Application Data
(60) Provisional application No. 63/388,438, filed on Jul. 12, 2022.

(51) Int. Cl. G01V 1/00

(52) U.S. Cl. CPC G01V 1/001; F24F 2120/10

(57) ABSTRACT

In embodiments of the disclosure, an occupancy detector includes a processor operable to perform processor operations that include receiving audio signals from a plurality of sources; performing analysis on the audio signals; and, based at least in part on a result of the analysis performed on the audio signals, making a determination of the audio signals that resulted from an action of a person located within an indoor area-under-evaluation.

### CROSS-REFERENCE TO RELATED APPLICATIONS

This application claims the benefit of U.S. Provisional Application No. 63/388,438 filed Jul. 12, 2022, the disclosure of which is incorporated herein by reference in its entirety.

### BACKGROUND

Exemplary embodiments of the present disclosure relate to occupancy detection systems, and more particularly to computing systems operable to implement an audio-based occupancy detection determination that can be used to control the operation of a variety of site-based systems, including, for example, a heating, ventilation, and air conditioning (HVAC) system.

Natural language processing (NLP) is a field of computer science, artificial intelligence, and computational linguistics concerned with the interactions between computers and humans using languages (i.e., natural languages). As such, NLP is related to the area of human-computer interaction. Among the challenges in implementing NLP systems is enabling computers to derive meaning from NL inputs, Included among NLP systems are conversational agents, digital assistants, machine translation (MT) systems and NLP Question & Answer (Q&A) systems.

### BRIEF DESCRIPTION

According to an embodiment, an occupancy detector includes a processor operable to perform processor operations that include receiving audio signals from a plurality of sources; performing analysis on the audio signals; and, based at least in part on a result of the analysis performed on the audio signals, making a determination of the audio signals that resulted from an action of a person located within an indoor area-under-evaluation.

In addition to one or more of the features described above, or as an alternative to any of the foregoing embodiments, the processor includes a machine learning algorithm having a machine learning model.

In addition to one or more of the features described above, or as an alternative to any of the foregoing embodiments, the machine learning model is trained to perform a task that includes performing the analysis on the audio signals; and, based at least in part on the result of the analysis performed on the audio signals, making the determination of the audio signals that resulted from the action of the person located within an indoor area-under-evaluation.

In addition to one or more of the features described above, or as an alternative to any of the foregoing embodiments, the indoor area-under evaluation is within a dwelling.

In addition to one or more of the features described above, or as an alternative to any of the foregoing embodiments, one or more of the processor operations are performed by a cloud computing system.

In addition to one or more of the features described above, or as an alternative to any of the foregoing embodiments, the processor operations further include based at least in part on the determination, generating an occupancy signal.

In addition to one or more of the features described above, or as an alternative to any of the foregoing embodiments, the processor operations further include sending the occupancy signal to a controller of a security system.

In addition to one or more of the features described above, or as an alternative to any of the foregoing embodiments, the processor operations further include sending the occupancy signal to a fire detection system.

In addition to one or more of the features described above, or as an alternative to any of the foregoing embodiments, the processor operations further include sending the occupancy signal to a controller of a heating, ventilation, and air conditioning (HVAC) system.

In addition to one or more of the features described above, or as an alternative to any of the foregoing embodiments, the HVAC system includes a zoned HVAC system.

According to another embodiment, a method of operating an occupancy detector includes a processor operable to perform processor operations that include receiving audio signals from a plurality of sources; performing analysis on the audio signals; and based at least in part on a result of the analysis performed on the audio signals, making a determination of the audio signals that resulted from an action of a person located within an indoor area-under-evaluation.

In addition to one or more of the features described above, or as an alternative to any of the foregoing embodiments, the processor includes a machine learning algorithm having a machine learning model.

In addition to one or more of the features described above, or as an alternative to any of the foregoing embodiments, the machine learning model is trained to perform a task that includes performing the analysis on the audio signals; and based at least in part on the result of the analysis performed on the audio signals, making the determination of the audio signals that resulted from the action of the person located within an indoor area-under-evaluation.

In addition to one or more of the features described above, or as an alternative to any of the foregoing embodiments, the indoor area-under evaluation is within a dwelling.

In addition to one or more of the features described above, or as an alternative to any of the foregoing embodiments, one or more of the processor operations are performed by a cloud computing system.

In addition to one or more of the features described above, or as an alternative to any of the foregoing embodiments, the processor operations further include, based at least in part on the determination, generating an occupancy signal.

In addition to one or more of the features described above, or as an alternative to any of the foregoing embodiments, the processor operations further include sending the occupancy signal to a controller of a security system.

In addition to one or more of the features described above, or as an alternative to any of the foregoing embodiments, the processor operations further includes sending the occupancy signal to a fire detection system.

In addition to one or more of the features described above, or as an alternative to any of the foregoing embodiments, the processor operations further include sending the occupancy signal to a controller of an HVAC system.

In addition to one or more of the features described above, or as an alternative to any of the foregoing embodiments, the HVAC system includes a zoned HVAC system.

### BRIEF DESCRIPTION OF THE DRAWINGS

The following descriptions should not be considered limiting in any way. With reference to the accompanying drawings, like elements are numbered alike:

FIG. 1 is a simplified block diagram of an exemplary audio-based occupancy detection system according to an embodiment;

FIG. 2 is a simplified block diagram of an exemplary audio-based occupancy detector according to an embodiment;

FIG. 3 is a simplified block diagram of a site having incorporated therein exemplary audio-based occupancy detectors according to an embodiment;

FIG. 4 is a flow diagram of an exemplary method according to an embodiment;

FIG. 5 is a block diagram illustrating how aspects of embodiments can be implemented using a classifier;

FIG. 6 is a block diagram of learning phase functionality that can be used to train the classifier shown in FIG. 5; and

FIG. 7 is a block diagram of a programmable computer system operable to implement aspects embodiments.

### DETAILED DESCRIPTION

A detailed description of one or more embodiments of the disclosed systems and methods are presented herein by way of exemplification and not limitation with reference to the Figures.

Known thermostats and HVAC systems can be more efficient if they leverage occupancy detection to put the system into an more energy efficient “away” mode. It could also be useful for other building systems and emergency responders to be made aware of home occupancy during an emergency such as a fire. However, it is difficult and/or expensive to have sensors in large number of the rooms in a home.

In embodiments of the disclosure, an audio-based occupancy detector is provided that is operable to always have a microphone enabled in order to detect and gather audio signals from a plurality of audio sources. Random noise within the home is leveraged to determine occupancy. The random noise can include such things as normal conversation, TV sounds, water running, cooking sounds, walking, etc. The audio-based occupancy detector includes algorithms and analysis engines to detect and process the audio signals so they can be efficiently and effectively analyzed (e.g., using trained machine learning models) to distinguish audio signals that are “person-originated” from audio signals that are “non-person-originated.” Person-originated notifications and non-person-originated notifications can be sent to controllers of other building systems and used to indicate a level of occupancy. This occupancy data could then be used by the controllers of HVAC systems, security systems, fire detection systems, and the like to optimize their performance/usage. In some embodiments, the audio-based occupancy detector could also be used in determining room occupancy in association with zoned HVAC systems. In some embodiments, the zoned HVAC system can be implemented as multiple separate HVAC systems where each HVAC system services selected zones of the site. In some embodiments, the zoned HVAC system can be implemented as a single HVAC system having sensors and dampers that can be operated in a manner that controls air flow to various zones of the site. In some embodiments, the zoned HVAC system can be implemented as multiple HVAC systems each having above-described sensors and dampers that can be operated in a manner that controls air flow to various zones of the site. The occupancy data can be communicated either locally via various wireless methods, or to a cloud-based server and back down to other devices. In some embodiments, the audio-based occupancy detector functionality can be incorporated into commercially available digital assistants that are often found in homes.

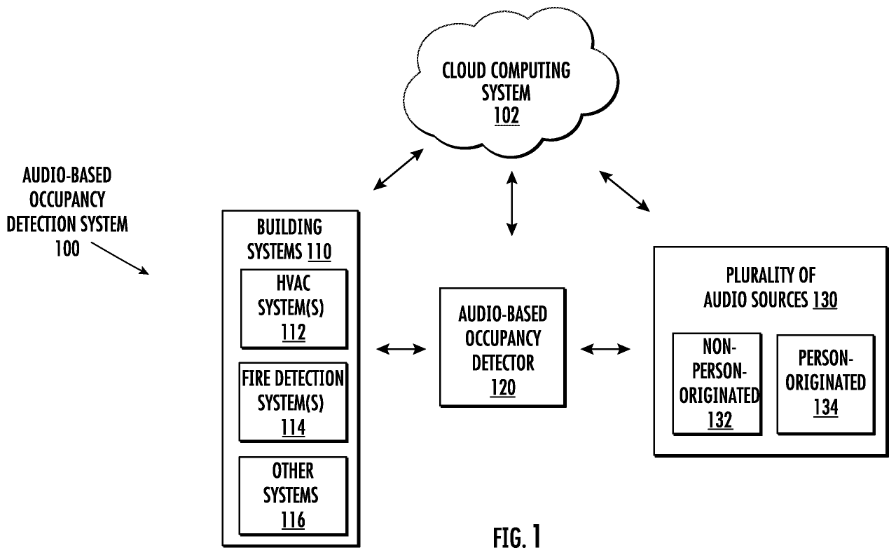

Turning now to a more detailed description of aspects of the present disclosure, as depicted in FIG. 1, embodiments provide an audio-based occupancy detection system 100 having an audio-based occupancy detector 120 communicatively coupled to a configuration of “smart” building systems 110. The adjective “smart” is often used to describe the use of computer-based, networked technologies to augment the features of a product or a system. Smart products are embedded with processors, sensors, software, and connectivity that allow data about the product to be gathered, processed, and transmitted to external systems. The data collected from smart/connected products can be analyzed and used to inform decision-making and enable operational efficiencies of the product. In embodiments, the audio-based occupancy detector 120 is operable to receive audio signals from a plurality of audio sources 130; determine whether the audio signals were originated by a person (e.g., non-person originated 132 or person-originated 134); and provide occupancy detection signals to downstream components such as the configuration of smart building systems 110. The plurality of audio sources 130 will include audio sources that are non-person originated 132 (e.g., a refrigerator turning on/off during it's normal operation cycle; a television, radio, or audio replay device generating sounds such as music, speech and/or sound effects; any sound that originates or is initiated from outside an indoor area-under-evaluation such as siren sounds, children playing outside, a doorbell ringing from someone outside the indoor area-under-evaluation pressing the doorbell button; and the like) and audio sources that are person-originated 134 (e.g., speech patterns and other noises (e.g., snoring, clearing the throat, coughing, laughing, and the like) of a person present in the indoor area-under-evaluation; and noises that are likely to result from an action taken by a person present in the indoor area-under-evaluation (e.g., a vacuum cleaner running, a water faucet running, a water faucet starting/stopping, a device (e.g., television, radio, or audio replay device) being turned on/off. The analysis performed by the audio-based occupancy detector 120 on the audio signals received from the plurality of audio sources 130 divides the received audio signals into person-originated 134 and non-person-originated 132. In some embodiments, the analysis performed by the audio-based occupancy detector 120 on the audio signals received from the plurality of audio sources 130 predicts whether the received audio signals are person originated 134 or non-person-originated 132. In some embodiments the analysis performed by the audio-based occupancy detector 120 includes sequence evaluations. For example, an audio signal that indicates a television was just turned on will be identified as a person-originated sound 134. However, if the audio signal that indicates a television was just turned on is followed by no person-originated sounds 134 for a predetermined period of time, the analysis can determine that a person turned on the television but subsequently left the room. The smart building systems 110 include a variety of building systems such as, for example, HVAC system 112, fire detections systems 114, and other systems 116. In embodiments, the HVAC system 112 can be implemented as a zoned HVAC system.

The cloud computing system 102 can be in wired or wireless electronic communication with one or all of components of the audio-based occupancy detection system 100. Cloud computing system 102 can supplement, support, or replace some or all of the functionality of the components of the audio-based occupancy detection system 100. Additionally, some or all of the functionality of the components of the audio-based occupancy detection system 100 can be implemented as a node of the cloud computing system 102.

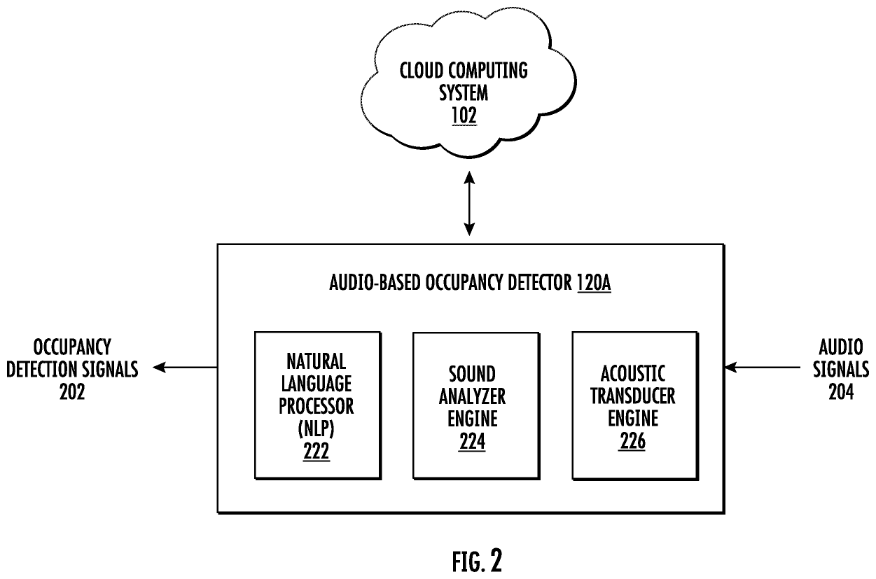

FIG. 2 depicts a non-limiting example of how the audio-based occupancy detector 120 (shown in FIG. 1) can be implemented as an audio-based occupancy detector 120A. The audio-based occupancy detector 120A can include a natural language processor (NLP) module 222, a sound analyzer engine 224, and an acoustic transducer engine 226. The modules and engines 222, 224, and 226 are provided as examples of signal processing techniques that can be used (in any combination) to prepare the received audio signals 204 as cleaner signals for prediction analysis by the audio-based occupancy detector 120A. In some embodiments of the disclosure, the prediction analysis is performed using machine learning algorithms and models (e.g., machine learning algorithm 512 and machine learning model 516) operable to vectorize the processed audio signals 204 to predict the audio signals 204 that are non-person originated 132 and predict the audio signals 204 that are person-originated 134. Based on the prediction of the audio signals 204 that are non-person originated 132 and the predication of the audio signals 204 that are person-originated 134, occupancy detection signals 202 are generated and provided to the building system 110.

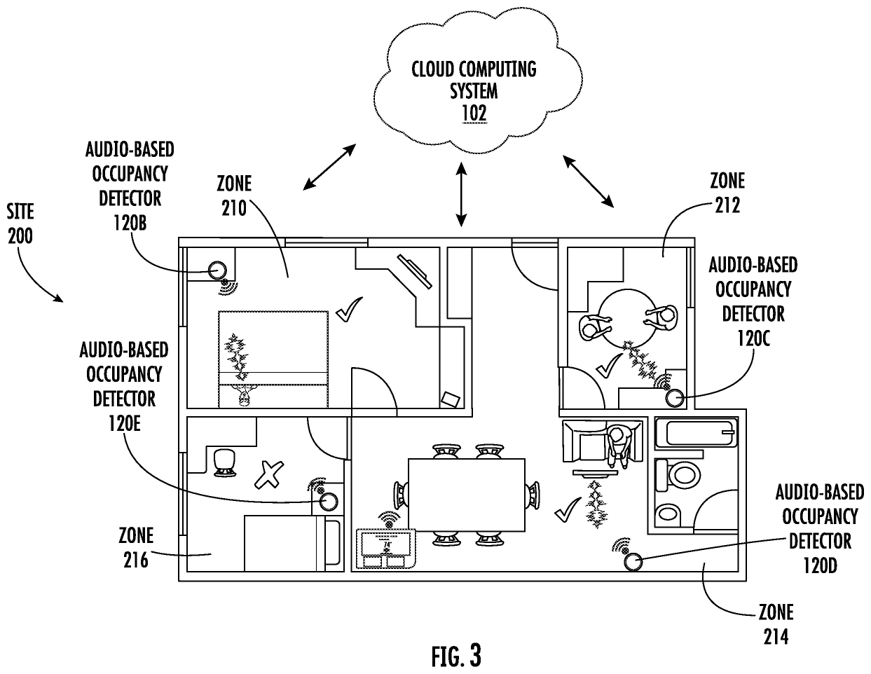

FIG. 3 depicts an example of how a network of audio-based occupancy detectors 120B, 120C, 120D, 120E can be incorporated within various Zones (or rooms) 210, 212, 214, 216 of a site 200. The site 200 can include, but is not limited to, dwellings, office buildings, manufacturing locations, warehouse areas, or any type of area that utilizes the smart building systems 110 (shown in FIG. 1). As shown, Zone 210 is occupied by a person who is sleeping and demonstrating an audible breathing pattern of a sleeping person. The person who is sleeping in Zone 210 may also occasionally snore, or (audibly) toss and turn in bed. All of the audio signals 204 are captured by the audio-based occupancy detector 120B and used to predict that the audio signals 204 include person-originated sounds 134 (the audible breathing pattern; snoring; and audibly tossing/turning in bed), which indicate that Zone 210 is occupied. The occupancy of Zone 210 is incorporated into the occupancy detection signals 202 and provided to the building systems 110.

As shown, Zone 212 is occupied by two people engaged in conversation. All of the audio signals 204 are captured by the audio-based occupancy detector 120C and used to predict that the audio signals 204 include person-originated sounds 134 (speech patterns of a person who is present in Zone 212 and speaking), which indicate that Zone 212 is occupied. The occupancy of Zone 212 is incorporated into the detection signals 202 and provided to the building systems 110.

As shown, Zone 214 is occupied by a single person who is watching a television program that is generating a variety of noises that include machine-transmitted human speech/conversation. Although the single person in Zone 214 is alone, and the primary noise is coming from the television program, the single person makes occasional noises such as laughing at a funny portion of the television program, walking across the room to the kitchen to pour a glass of water, clearing his/her throat, and the like. All of the audio signals 204 are captured by the audio-based occupancy detector 120D and used to predict that the audio signals 204 include both non-person-originated sounds 132 (e.g., the variety of noises generated by the television program) and person-originated sounds 134 (the speech patterns and other noises (walking sounds) from the single person who is present in Zone 214), which indicate that Zone 214 is occupied. The occupancy of Zone 214 is incorporated into the detection signals 202 and provided to the building systems 110.

As shown, Zone 216 is unoccupied by a person. All of the audio signals 204 are captured by the audio-based occupancy detector 120E and used to predict that the audio signals 204 include no non-person originated sounds 132 and no person-originated sounds 134, which indicate that Zone 216 is unoccupied. In another example, Zone 216 is unoccupied by a person, but a radio (not shown) was inadvertently left on by the last person to occupy Zone 216. All of the audio signals 204 are captured by the audio-based occupancy detector 120E and used to predict that the audio signals 204 include non-person originated sounds 132 (the variety of noises generated by the radio including songs, sound effects (horn honking in an advertising spot), and machine-transmitted human speech/conversation) and no person-originated sounds 134 (e.g., speech patterns and other noises (walking sounds, turning on and/or stopping a water faucet, opening and closing a refrigerator door, flipping a light switch, and the like) from the single person who is present in Zone 214, which indicate that Zone 216 is unoccupied. In another example, the radio being turned on would be initially analyzed as a person-originated sound 134, and after no person-originated sounds 134 are detected for a predetermined period of time, the sequence of a person-originated sound 134 followed by no person-originated sounds 134 for a predetermined period of time would be analyzed as Zone 216 going from being occupied to being unoccupied. In any of the above examples, the occupancy of Zone 216 is incorporated into the detection signals 202 and provided to the building systems 110.

In some embodiments, the network of audio-based occupancy detectors 120B, 120C, 120D, 120E shown in FIG. 3 can be implemented as a centralized audio-based occupancy detector coupled to individual microphones in each Zone (or room) 210, 212, 214, 216 of the site 200. In this centralized configuration, each microphone is associated with a particular Zone and provides audio signals from each Zone back to the centralized audio-based occupancy detector. The audio analysis operations performed in a distributed fashion by the network of audio-based occupancy detectors 120B, 120C, 120D, 120E can instead be performed at the centralized audio-based occupancy detector.

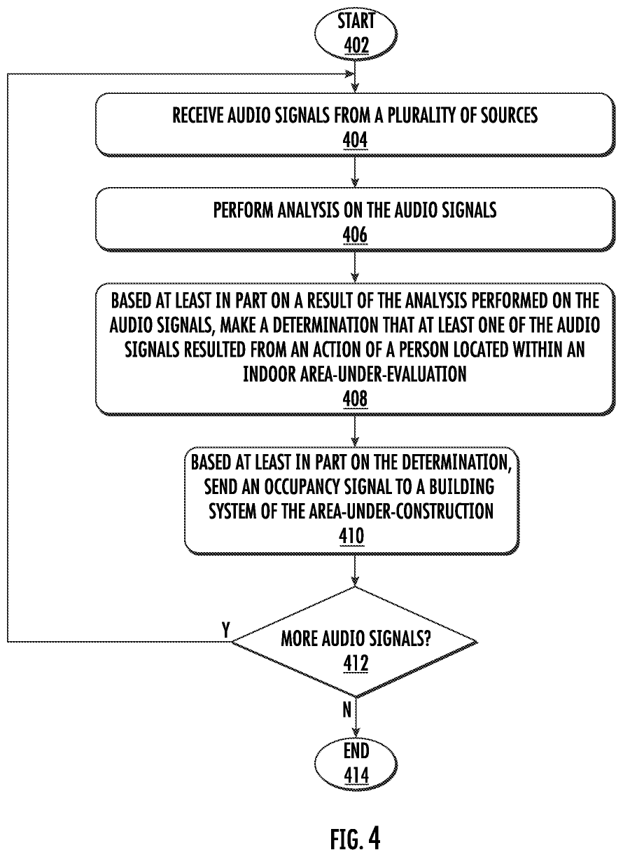

FIG. 4 is a flow diagram of an exemplary methodology 400 according to an embodiment. The methodology 400 is performed by the audio-based occupancy detectors 120-120E (shown in FIGS. 1, 2 and 3). The methodology 400 starts at block 402 then moves to block 404 where audio signals are received from a plurality of sources. At block 406, the methodology 400 performs analysis on the audio signals, and at block 408, based at least in part on a result of the analysis performed on the audio signals, the audio-based occupancy detectors make a determination that at least one of the audio signals resulted from an action of a person located within an indoor area-under-evaluation. In some embodiments, at block 408, the audio-based occupancy detector(s) makes a determination of the audio signals that resulted from an action of a person located within an indoor area-under-evaluation. In some embodiments, the determination made at block 408 is based solely on the result of the analysis.

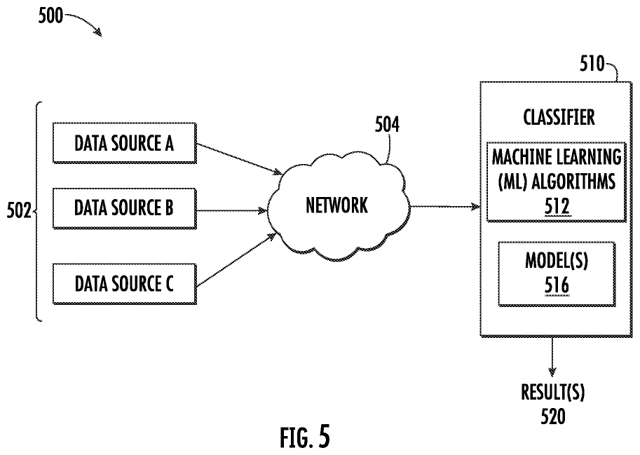

In some embodiments, the operations at block 408 can be performed using a machine learning algorithm and a machine learning model (e.g., machine learning algorithm 512 and machine learning model 516 shown in FIG. 5) trained to perform the task of predicting whether the received audio signals include non-person-originated signals/sounds and/or person-originated signals/sounds. In some embodiments, the machine learning model is trained to include a model of human-originated sounds, a model of non-human-originated sounds, a temporal model (e.g., for determining the previously-described predetermined period of time), and a model of the relevant site (in any combination). In embodiments, block 408 continues to predict the non-human-originated sounds and the human-originated sounds until the confidence level (CL) of the predictions exceed a threshold (TH). In aspects of the embodiments, the machine learning algorithms 512 and the machine learning models 516 can be configured to apply CLs to various ones of their results/determinations in order to improve the overall accuracy of the particular result/determination. When the machine learning algorithms 512 and/or the machine learning models 516 make a determination or generate a result for which the value of CL is below a predetermined TH (i.e., CL<TH), the result/determination can be classified as having sufficiently low “confidence” to justify a conclusion that the determination/result is not valid, and this conclusion can be used to determine when, how, and/or if the determinations/results are handled in downstream processing. If CL>TH, the determination/result can be considered valid, and this conclusion can be used to determine when, how, and/or if the determinations/results are handled in downstream processing. Many different predetermined TH levels can be provided. The determinations/results with CL>TH can be ranked from the highest CL>TH to the lowest CL>TH in order to prioritize when, how, and/or if the determinations/results are handled in downstream processing. Many different predetermined TH levels can be provided such that the results 520 with CL>TH can be ranked from the highest CL>TH to the lowest CL>TH.

From block 408, the methodology 400 moves to block 410 to, based at least in part on the determination, send an occupancy signal to a building system of the area-under-consideration. After the operations at block 408 are completed, the methodology 400 moves to decision block 412 to determine whether there are more audio signals to evaluate. If the answer to the inquiry at decision block 412 is yes, the methodology 400 returns to block 404 to select additional audio signals and perform another iteration of the methodology 400. If the answer to the inquiry at decision block 412 is no, the methodology 400 move to block 414 and ends.

Additional details of machine learning techniques that can be used to implement functionality of the audio-based occupancy detectors 120-120E will now be provided. The various classification, prediction and/or determination functionality of the controllers or processors described herein can be implemented using machine learning and/or natural language processing techniques. In general, machine learning techniques are run on so-called “learning machines,” which can be implemented as programmable computers operable to run sets of machine learning algorithms and/or natural language processing algorithms. Machine learning algorithms incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of learning machines and their machine learning algorithms is to recognize patterns by interpreting unstructured sensor data through a kind of machine perception. Unstructured real-world data in its native form (e.g., images, sound, text, or time series data) is converted to a numerical form (e.g., a vector having magnitude and direction) that can be understood and manipulated by a computer. The machine learning algorithm performs multiple iterations of learning-based analysis on the real-world data vectors until patterns (or relationships) contained in the real-world data vectors are uncovered and learned. The learned patterns/relationships function as predictive models that can be used to perform a variety of tasks, including, for example, classification (or labeling) of real-world data and clustering of real-world data. Classification tasks often depend on the use of labeled datasets to train the classifier (i.e., the model) to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Clustering tasks identify similarities between objects, which the clustering task groups according to those characteristics in common and which differentiate them from other groups of objects. These groups are known as “clusters.”

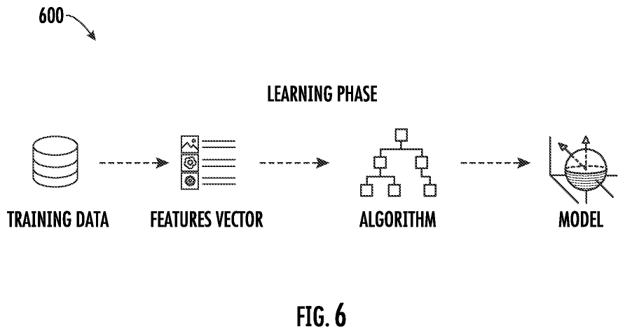

An example of machine learning techniques that can be used to implement embodiments of the disclosure will be described with reference to FIGS. 5 and 6. FIG. 5 depicts a block diagram showing a classifier system 500 capable of implementing various predicting and determining aspects of the embodiments described herein. More specifically, the functionality of the system 500 is used in embodiments of the disclosure to generate various models and/or sub-models that can be used to implement predicting and determining functionality in embodiments of the disclosure. The classifier system 500 includes multiple data sources 502 in communication (e.g., through a network 504) with a classifier 510. In some embodiments of the disclosure, the data sources 502 can bypass the network 504 and feed directly into the classifier 510. The data sources 502 provide data/information inputs that will be evaluated by the classifier 510 in accordance with embodiments of the disclosure. The data sources 502 also provide data/information inputs that can be used by the classifier 510 to train and/or update model(s) 516 created by the classifier 510. The data sources 502 can be implemented as a wide variety of data sources, including but not limited to, sensors operable to gather real time data, data repositories (including training data repositories), and outputs from other classifiers. The network 504 can be any type of communications network, including but not limited to local networks, wide area networks, private networks, the Internet, and the like.

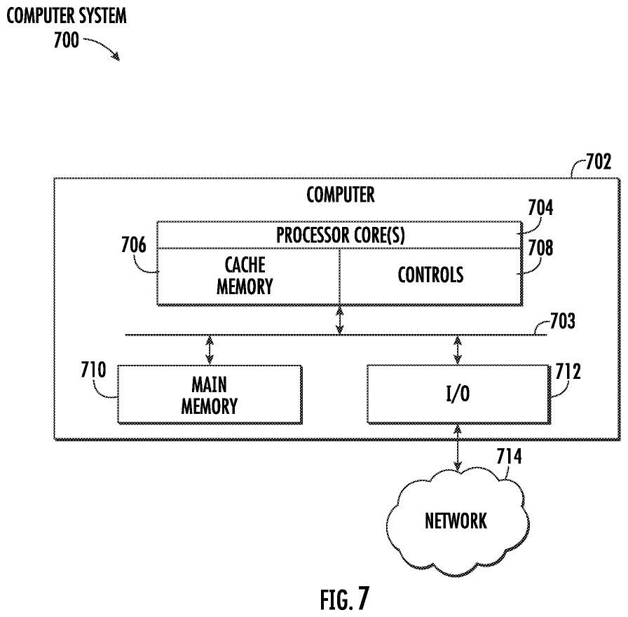

The classifier 510 can be implemented as algorithms executed by a programmable computer such as the computing system 700 (shown in FIG. 7). As shown in FIG. 5, the classifier 510 includes a suite of machine learning (ML) algorithms 512; and model(s) 516 that are relationship (or prediction) algorithms generated (or learned) by the ML algorithms 512. The algorithms 512, 516 of the classifier 510 are depicted separately for ease of illustration and explanation. In embodiments of the disclosure, the functions performed by the various algorithms 512, 516 of the classifier 510 can be distributed differently than shown. In some embodiments of the disclosure, natural language processing (NLP) algorithms can be integrated within the ML algorithms 512.

Referring now to FIGS. 5 and 6 collectively, FIG. 6 depicts an example of a learning phase 600 performed by the ML algorithms 512 to generate the above-described models 516. In the learning phase 600, the classifier 510 extracts features from the training data and coverts the features to vector representations that can be recognized and analyzed by the ML algorithms 512. The features vectors are analyzed by the ML algorithm 512 to “classify” the training data against the target model (or the model's task) and uncover relationships between and among the classified training data. Examples of suitable implementations of the ML algorithms 512 include but are not limited to neural networks, support vector machines (SVMs), logistic regression, decision trees, hidden Markov Models (HMMs), etc. The learning or training performed by the ML algorithms 512 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier 510 and the ML algorithms 512. Unsupervised learning can utilize additional learning/training methods including, for example, clustering, anomaly detection, neural networks, deep learning, and the like.

When the models 516 are sufficiently trained by the ML algorithms 512, the data sources 502 that generate “real world” data are accessed, and the “real world” data is applied to the models 516 to generate usable versions of the results 520. In some embodiments of the disclosure, the results 520 can be fed back to the classifier 510 and used by the ML algorithms 512 as additional training data for updating and/or refining the models 516.

FIG. 7 illustrates an example of a computer system 700 that can be used to implement the controller 120 described herein. The computer system 700 includes an exemplary computing device (“computer”) 702 configured for performing various aspects of the content-based semantic monitoring operations described herein in accordance embodiments of the disclosure. In addition to computer 702, exemplary computer system 700 includes network 714, which connects computer 702 to additional systems (not depicted) and can include one or more wide area networks (WANs) and/or local area networks (LANs) such as the Internet, intranet(s), and/or wireless communication network(s). Computer 702 and additional system are in communication via network 714, e.g., to communicate data between them.

Exemplary computer 702 includes processor cores 704, main memory (“memory”) 710, and input/output component(s) 712, which are in communication via bus 703. Processor cores 704 includes cache memory (“cache”) 706 and controls 708, which include branch prediction structures and associated search, hit, detect and update logic, which will be described in more detail below. Cache 706 can include multiple cache levels (not depicted) that are on or off-chip from processor 704. Memory 710 can include various data stored therein, e.g., instructions, software, routines, etc., which, e.g., can be transferred to/from cache 706 by controls 708 for execution by processor 704. Input/output component(s) 712 can include one or more components that facilitate local and/or remote input/output operations to/from computer 702, such as a display, keyboard, modem, network adapter, etc. (not depicted).

Embodiments of the disclosure described herein can be a system, a method, and/or a computer program product at any possible technical detail level of integration. The computer program product can include a computer readable storage medium (or media) having computer readable program instructions thereon for causing a controller or processor to carry out aspects of the embodiments of the disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An occupancy detector comprising a processor operable to perform processor operations comprising:
receiving audio signals from a plurality of sources;
performing analysis on the audio signals; and
based at least in part on a result of the analysis performed on the audio signals, making a determination of the audio signals that resulted from an action of a person located within an indoor area-under-evaluation.

2. The occupancy detector of claim 1, wherein the processor comprises a machine learning algorithm having a machine learning model.

3. The occupancy detector of claim 2, wherein the machine learning model is trained to perform a task comprising:
performing the analysis on the audio signals; and
based at least in part on the result of the analysis performed on the audio signals, making the determination of the audio signals that resulted from the action of the person located within an indoor area-under-evaluation.

4. The occupancy detector of claim 1, wherein the indoor area-under evaluation is within a dwelling.

5. The occupancy detector of claim 1, wherein one or more of the processor operations are performed by a cloud computing system.

6. The occupancy detector of claim 1, wherein the processor operations further comprise, based at least in part on the determination, generating an occupancy signal.

7. The occupancy detector of claim 6, wherein the processor operations further comprise sending the occupancy signal to a controller of a security system.

8. The occupancy detector of claim 6, wherein the processor operations further comprise sending the occupancy signal to a controller of a fire detection system.

9. The occupancy detector of claim 6, wherein the processor operations further comprise sending the occupancy signal to a controller of a heating, ventilation, and air conditioning (HVAC) system.

10. The occupancy detector of claim 9, wherein the HVAC system comprises a zoned HVAC system.

11. A method of operating an occupancy detector comprising a processor operable to perform processor operations comprising:
receiving audio signals from a plurality of sources;
performing analysis on the audio signals; and
based at least in part on a result of the analysis performed on the audio signals, making a determination of the audio signals that resulted from an action of a person located within an indoor area-under-evaluation.

12. The method of claim 11, wherein the processor comprises a machine learning algorithm having a machine learning model.

13. The method of claim 12, wherein the machine learning model is trained to perform a task comprising:
performing the analysis on the audio signals; and
based at least in part on the result of the analysis performed on the audio signals, making the determination of the audio signals that resulted from the action of the person located within an indoor area-under-evaluation.

14. The method of claim 11, wherein the indoor area-under evaluation is within a dwelling.

15. The method of claim 11, wherein one or more of the processor operations are performed by a cloud computing system.

16. The method of claim 11, wherein the processor operations further comprise, based at least in part on the determination, generating an occupancy signal.

17. The method of claim 16, wherein the processor operations further comprise sending the occupancy signal to a controller of a security system.

18. The method of claim 16, wherein the processor operations further comprise sending the occupancy signal to a fire detection system.

19. The method of claim 16, wherein the processor operations further comprise sending the occupancy signal to a controller of a heating, ventilation, and air conditioning (HVAC) system.

20. The method of claim 19, wherein the HVAC system comprises a zoned HVAC system.
